(19) United States
(12) Patent Application Publication
(10) Pub. No.: US 2012/0237662 A1
(43) Pub. Date: Sep. 20, 2012

(54) METHOD OF MAKING A REDUCED FAT CHOCOLATE CONFECTIONERY PRODUCT

(75) Inventors: Xiaoying WANG, Hummelstown, PA (US); Gregory T. ZERPHY, Elizabethtown, PA (US); Julie HICKEY, Hummelstown, PA (US)

(73) Assignee: THE HERSHEY COMPANY, Hershey, PA (US)

(21) Appl. No.: 13/422,205

(22) Filed: Mar. 16, 2012

Related U.S. Application Data
(60) Provisional application No. 61/454,010, filed on Mar. 18, 2011.

(51) Int. Cl. A23G 1/36; A23G 3/40; A23G 1/46; A23G 1/48; A23G 1/32

(52) U.S. Cl. 426/588; 426/660; 426/631; 426/580

(57) ABSTRACT

A method for creating a reduced fat confectionery product is disclosed. The method includes providing a mixture of a chocolate compatible fat and a sweetener, thereafter refining the mixture to form a powder having a predetermined average particle size, thereafter agitating the refined powder mixture at a temperature above the melting temperature of the chocolate compatible fat to form a dough and thereafter solidifying the dough to form a confectionery product having a total formulated fat content of less than 29% by weight.

### RELATED APPLICATIONS

This application claims the benefit of and priority to U.S. Provisional Application No. 60/454,010 filed Mar. 18, 2011.

### FIELD

This application is directed to the manufacture of confectionery products and more particularly to the manufacture of chocolate and chocolaty candy having reduced levels of fat.

### BACKGROUND

Traditional chocolate making methods are well known and involve several basic steps carried out in a particular order. Generally, the process starts with cocoa beans harvested from pods of melon-like fruit that grow on the cacao tree. The cocoa beans are removed from the pods and placed in large heaps or piles to ferment, during which the shells of the beans harden and darken and a rich cocoa flavor develops.

Dried cocoa beans are roasted at very high temperatures and hulled to separate the shell from the inside of the bean, also called a “nib,” the part of the bean actually used to make chocolate. The nibs are milled by a grinding process that turns the nibs into a liquid called chocolate liquor.

The chocolate liquor, which is sometimes separated in advance into its constituents, cocoa butter and cocoa powder, is mixed with a sweetener, usually sugar, and in the case of milk chocolate, milk solids are also added.

The chocolate liquor is also combined with milk and sugar and is dried to a coarse, brown powder called chocolate crumb. Additional cocoa butter may be added to the chocolate crumb, after which the mixture passes through steel rollers which refine the mixture above the melting point of the cocoa butter, resulting in a chocolate powder. The chocolate powder is then conched, a process in which the chocolate powder is maintained above the fat melting temperature while mixing elements smooth out gritty particles, remove moisture and off-flavors, and develop pleasant flavors. Conching also releases fat from the chocolate powder, increasing the fat coating on the particles so that the chocolate has a proper fluidity for further processing. Additional fat is added to achieve the full formulated fat content and emulsifiers are also added to reduce viscosity and enhance fluidity of the chocolate paste. The liquid chocolate paste is tempered and then poured or deposited into a mould to produce a chocolate bar or used for enrobed products.

Chocolate confectionery products are typically formulated so that the total formulated fat content is at least 29% by weight or greater. As a result, chocolate confections are often avoided by persons that may be dieting or have various dietary restrictions related to fat or high calorie intake. Attempts have been made to make chocolate and chocolaty candy bars with fat content below 29% using traditional methods by addition of emulsifiers such as lecithin, polyglycerol polyricinoleate (PGPR) and ammonium phosphatide (YN) in combination with larger particle sizes. However because of the larger particle sizes, these products have an undesirable grainy texture. Furthermore, chocolate and chocolaty candy bar products have generally not been formed with fat contents lower than about 24% because they contain insufficient fat to form the liquid chocolate paste and as a result, cannot be used in traditional moulding, depositing, and enrobing applications.

These and other drawbacks are associated with current methods of confectionery production.

### SUMMARY

Exemplary embodiments are directed to producing chocolate confectionery products that do not need to be specially formulated and can be made with traditional chocolate making ingredients but to a lower overall fat content, but which still exhibit satisfactory taste and texture characteristics comparable to traditional chocolate products and can also be shaped or formed into a candy bar format.

In one embodiment, a method for creating a confectionery product comprises providing a mixture comprising a chocolate compatible fat and a sweetener; thereafter refining the mixture to form a powder having a predetermined average particle size; thereafter agitating the refined powder mixture at a temperature above the melting temperature of the chocolate compatible fat to form a dough; and thereafter solidifying the dough to form a confectionery product having a total formulated fat content of less than 29% by weight.

In another embodiment, a method for creating a confectionery product comprises providing a mixture comprising a chocolate compatible tempering fat, milk, cocoa solids, sugar and an emulsifier; thereafter refining the mixture to form a chocolate powder having an average particle size in the range of about 15 to about 40 microns at a temperature greater than the melting temperature of the chocolate compatible tempering fat; thereafter agitating the refined chocolate powder mixture at a temperature above the melting temperature of the chocolate compatible tempering fat to form a dough in the presence of an additional added emulsifier; tempering the dough in the presence of greater than about 0.3% by weight tempering seed; forming the dough into a predetermined shape; and thereafter solidifying the dough to form a confectionery product having a total formulated fat content of 27% or less by weight.

Another advantage is that chocolate confectionery products produced in accordance with exemplary embodiments can be formulated with less than the overall fat content as chocolate confectioneries produced by traditional methods.

Yet another advantage is that methods in accordance with exemplary embodiments can produce chocolate confections using traditional chocolate making ingredients and refine to normal particle size of about 25 microns which avoids the use of large particle sizes that results in undesirable eating qualities.

Confections made in accordance with exemplary embodiments may also exhibit enhanced heat stability.

Other features and advantages of the present invention will be apparent from the following more detailed description of exemplary embodiments, taken in conjunction with the accompanying drawings which illustrate, by way of example, the principles of the invention.

### DETAILED DESCRIPTION OF EXEMPLARY EMBODIMENTS

Exemplary embodiments are directed to methods of producing a chocolate confectionery product that does not need to be specially formulated and can be made with traditional chocolate making ingredients and which has a lower total fat content but still has comparable taste and mouthfeel of chocolate confections made by traditional methods and can also be formed into a candy bar format. Exemplary embodiments include sequential steps of providing a blended mixture followed by refining and agitating/kneading to obtain a chocolate dough that can be shaped and solidified to form the confectionery product.

It will be appreciated that the term “chocolate” may have a legal definition in certain countries relative to particular amounts of cocoa solids, cocoa butter or other ingredients, such as milk fat and/or milk powder, and that the definition may vary from country to country. As used herein, however, the term “chocolate confection” or “chocolate confectionery product” is meant to encompass the broad category of any confectionery product that includes a chocolate compatible fat, including traditional chocolate containing cocoa solids and cocoa butter, as well as those products sometimes referred to as chocolaty candy or chocolate compound that make use of additional fats and/or chocolate flavorings in place of cocoa solids and/or cocoa butter, along with the category of candy known as white chocolate.

According to exemplary embodiments, a blended mixture of a chocolate compatible fat, a sweetener and an emulsifier is provided, which is sometimes referred to as batching. Typically, the mixture further includes cocoa solids, but which may be eliminated, for example, in methods for producing white chocolate. The cocoa solids may be introduced, for example, as cocoa powder and/or as chocolate liquor in which the cocoa solids are not yet separated from the cocoa butter.

Preferably, the sweetener is a dry sweetener, although the use of other alternatives is not precluded. The sweetener may be sugar, but other sweeteners such as polyols, corn syrup solids, fructo-oligosaccharide/inulin, all by way of example only, may also be used. Because of the low-fat nature of confections made in accordance with exemplary embodiments, it may be desirable to use alternative sweeteners such as polyols, to further reduce calories in the manufactured product or to make a sugar free product.

One or more emulsifiers, such as lecithin, polyglycerol polyricinoleate (PGPR), or ammonium phosphatide (YN), may be added depending on the formulated fat content. In some embodiments, emulsifiers are added when the formulated fat content is about 24% or less by weight. The emulsifiers aid in achieving a dough at lower fat contents, but are generally added in low amounts, typically in the range of 0.3% up to about 2% by weight, preferably in the range of 0.5% to 1% by weight. Greater amounts may adversely affect the mixture's ability to retain its dough form. Preferably, a portion of the total amount of emulsifier in the confection is added during initial mixture formulation, while the balance is added during kneading as described subsequently.

The chocolate compatible fat is preferably cocoa butter, but may also be any of the vegetable or other fats known in the chocolate industry for use in combination with or in place of cocoa butter. Such fats are typically classified as one of the following categories: cocoa butter equivalents (e.g., fractionated palm oil, illipe and shea nut butter), cocoa butter replacements (e.g., fractionated and partially hydrogenated soybean, cottonseed and palm oils) and cocoa butter substitutes (e.g., fractionated and partially hydrogenated lauric fat compounds). The chocolate compatible fat may be any of the foregoing categories of fats or may be a combination of one or more types of fats from different categories.

As already noted, in some embodiments, chocolate liquor may be used to introduce both cocoa solids and cocoa butter; in that case, additional chocolate compatible fat may be blended into the mixture to achieve the desired total fat content. When chocolate confections are made using chocolate liquor as part of the formulation, the chocolate liquor may contain high levels of unpleasant notes and the mixture may be subjected to a pre-refining conch process. A post-refining conch process may also be used, particularly in embodiments in which the formulated fat content is about 22% by weight or less. The conch process involves mixing the blended mixture at elevated temperatures (above the fat melting temperature) for several or more hours, e.g. at 50° C. for 3 hours, to remove off notes and develop pleasant flavors.

The total formulated fat content may include both chocolate compatible fats and milk fat. In some embodiments, the total formulated fat content of the chocolate confection is less than 27% by weight, in some cases 25% by weight or less, typically 23% by weight or less, and as low as about 18% by weight. In some embodiments the fat content is in the range about 20% to about 22% by weight. The total fat content in the blended mixture contains about 95% to 100% of the total formulated fat in the confectionery product to be produced. The balance of any remaining fat may added during refining, kneading and/or tempering.

For embodiments such as white chocolate and milk chocolate confections, milk may be blended into the mixture. The milk may be provided as powdered milk; alternatively, liquid milk may also be used but which may introduce an intermediate drying step to remove excess moisture prior to refining. Furthermore, the powdered milk may contain fat or may be nonfat. In those embodiments in which the milk contains fat, the amount of chocolate compatible fat may be adjusted to maintain the total formulated fat content within the desired range. It will further be appreciated that in some embodiments, such as in the manufacture of dark chocolate confections, it may be desirable to provide milk fat but not milk solids. In such cases the amount of chocolate compatible fat may be adjusted to maintain the total formulated fat content within the desired range. In some embodiments, additives such as soy protein, rice flour and the like may be added in addition to or in place of milk solids.

One of the advantages achieved with exemplary embodiments is that the blended mixture can be any desired chocolate confection formulation and uses traditional chocolate ingredients, but at lower overall fat content. It will thus be appreciated that the amounts of cocoa, sugar or other sweetener, chocolate compatible fat, milk (including milk fat and/or milk solids) can be added in such proportions to achieve any desired flavor characteristics.

It will further be appreciated that flavorants, such as natural vanilla, vanillin or other extracts, as well as preservatives, such as tocopherols, and other minor ingredients and additives may also be blended into the mixture.

The provided mixture, having the types and amounts of ingredients according to a particular confection formulation, is blended above the melting temperature of the chocolate compatible fat to obtain a thorough mixing, following which the mixture is refined. The refining results in decreased particle size of the mixture, generally in the range of about 15 to about 40 microns, typically in the range of about 25 to about 30 microns. The reduction of particle size increases the surface area of the non-fat ingredients. More free fats are trapped to the newly formed surface, resulting in a dry chocolate powder from the liquid blend introduced to the refiner.

Refining can be accomplished using conventional refining equipment. The refine temperature should be at or above the melting temperature of the chocolate compatible fat, to increase the amount of free fat available to coat the particles. In some exemplary embodiments, sugar or other sweeteners can be milled or pulverized to the desired particle size and incorporated into the refined material before kneading.

In traditional chocolate making processes, output from the refiner is conched at elevated temperature for several hours during which time fat is released from refined chocolate powder, coated onto all of the refined particles, and the remaining fat to reach the final fat content is added along with emulsifiers to obtain a final flowable liquid chocolate that has a Bingham or pseudoplastic-like fluid behavior.

Conversely, according to exemplary embodiments, the post-refined mixture is instead subjected to agitation via a slow kneading process carried out at or above the melting temperature of the chocolate compatible fat to form a dough. During the kneading process, additional emulsifiers (e.g., lecithin, PGPR, or ammonium phosphatide (YN)) are added to obtain a non-flowable chocolate dough under the reduced fat conditions to achieve a total emulsifier content in the weight range previously described. The kneading stops when the post-refined material forms the non-flowable chocolate dough, which may take several hours. In some exemplary embodiments in which the fat content is not fully formulated fat prior to refining, the remaining fat can be added during the dough forming stage.

The conclusion of the kneading process is reached when the post-refined mixture reaches the dough stage. Over-kneading can modify the rheology from the desired dough stage to a more liquid-like paste like that in traditional chocolate processing. Nuts, coconut, and other types of inclusions commonly incorporated into chocolate confections can be added during kneading to incorporate these additional ingredients into the end product. While the distinction between a dough formed according to the processes described in accordance with exemplary embodiments and a flowable paste or liquid formed in accordance with traditional chocolate making methods will be readily apparent to those of ordinary skill in the art, the dough may further be characterized as exhibiting a minimum resistance force of 1.5×10⁴ Pa under a compression deformation of 2.5 mm at 0.2 mm/sec penetration speed using a 0.25 inch diameter plastic cylindrical probe at 45° C., or a minimum peak force of 50 grams using TA-XT2 Analyser under those conditions.

Because exemplary embodiments are directed to forming a chocolate dough prior to final piece forming of the chocolate confection, the amount of kneading and additional added emulsifier may depend on the total formulated fat content for the product. Embodiments below about 22% total formulated fat may require longer kneading times and more emulsifier to release enough fat to result in the formation of the dough.

In embodiments in which the chocolate compatible fat is or includes a tempering fat, the chocolate dough may be tempered by adding pre-made tempering seeds at 0.3% by weight or greater, typically 1% by weight or greater. The tempering seeds may be small particles of chocolate, cocoa butter, or another tempering fat, and as such may contribute to the total formulated fat content. The seeds are incorporated into the dough during kneading, which incorporation should be carried out at a temperature sufficient so that the seeds do not melt entirely away and lose their crystal structure, typically in the range of about 27° C. to about 33° C., preferably about 29.5° to about 31° C. In some embodiments, this may be achieved by kneading above this temperature range at early stages of kneading, followed by cooling to this range and adding the seeds and thereafter further kneading the seeds into and holding the dough in this temperature range in the presence of the seeds to achieve the desired crystalline structure. In other embodiments, the kneading may occur within this temperature range so that an additional cooling step is not needed prior to addition of the tempering seeds.

The resultant chocolate dough can then be shaped and solidified to form the chocolate confectionery product. Because the chocolate dough is not flowable, it is formed into its shape for ultimate consumption other than by the liquid depositing or enrobing used in traditional chocolate making. The chocolate dough can be formed into pieces of any desired shape by any suitable shaping methods such as rotary molding, sheeting, extrusion, depositing, drop rolling, stamping, frozen cone, or panning all by way of example.

In one embodiment, a rotary moulding machine may be used to shape and form the chocolate confectionery product. The moulding machine includes a water jacketed roll to which a die of a desired shape is mounted. The roll temperature may be controlled within the chocolate dough working range, typically 27° C.- to 33° C. for tempered chocolate and more preferably 29.5° C. to- 31° C. For embodiments in which a non-tempering chocolate compatible fat is employed, the dough working range may be any suitable temperature at or above the fat melting temperature and the roll temperature may be controlled accordingly.

After forming into the desired piece shape, the chocolate confection may then be cooled in a cooling tunnel or other conventional technique for piece solidification. In some embodiments, it may be desirable to apply a confectionery glaze or shellac over the pieces after shaping, either prior to or after solidification.

Chocolate confectionery products made in accordance with exemplary embodiments of the invention employ chocolate dough having a firm, pliable rheology formed above the melting temperature of the chocolate compatible fat used to create the confection. As a result, that is also the rheology to which the chocolate confection reverts if the confection is subsequently heated back above the fat melting temperature, as might be the case in hot weather and/or tropical climates. Despite the lower amount of total formulated fats, chocolate confections in accordance with exemplary embodiments still result in a smooth, non-grainy texture with a satisfying mouthfeel and flavor while consuming less fat and calories than in a traditional chocolate bar.

### EXAMPLES

The invention is further described in the context of the following examples, which are presented by way of illustration, not of limitation.

### Example 1

A reduced fat chocolate confection was made by blending the ingredients in the weight percentages according to the formula set forth below; the formulated mixture had a total fat content of 20% by weight.

| | |
|---|---|
| Cocoa liquor | 15 |
| Sugar | 52 |
| Non-fat milk powder | 16 |
| Cocoa powder | 1.3 |
| Lactose | 4.0 |
| Milk fat | 4.5 |
| Cocoa butter | 6.4 |
| Lecithin | 0.4 |
| PGPR | 0.3 |
| Vanillin | 0.02 |

All ingredients except PGPR and approximately half of the lecithin (0.23% of the total formula weight percent) were weighed into a Hobart bowl and mixed well at 35° C. The mixture was then refined to a particle size in the range of about 20-25 microns with the refiner setting at 35° C., above the melting point of the cocoa butter. The refined material was agitated in excess of 5 hours while being heated to a temperature in the range of about 46° C., above the melting point of the cocoa butter. The PGPR and the balance of the lecithin was added at the end of the kneading.

The dough was cooled to 30° C. and chocolate seeds were added. Mixing was continued at that temperature until the seeds were uniformly distributed into the chocolate dough. The chocolate dough was then pressed into a mould, cooled in a refrigerator for approximately 30 minutes and then demoulded.

### Example 2

A reduced fat white chocolate confection was made by blending the ingredients in the weight percentages according to the formula set forth below; the formulated mixture had a total fat content of 21% by weight.

| | |
|---|---|
| Sugar | 51 |
| Non-fat milk powder | 28 |
| Milk fat | 8.3 |
| Cocoa butter | 12 |
| Lecithin | 0.4 |
| PGPR | 0.3 |
| Vanillin | 0.02 |

All ingredients except PGPR and 0.23% Lecithin were weighed into a Hobart bowl and mixed well at 45° C. The mixture was then refined to a particle size of about 25 microns with the refiner setting at 40° C. The refined material was agitated for about 1 hour with addition of PGPR and remaining lecithin at 45° C. to form a white chocolate dough.

### Example 3

A reduced fat dark chocolate confection was made by blending the ingredients in the weight percentages according to the formula set forth below; the formulated mixture had a total fat content of 22.7% by weight.

| | |
|---|---|
| Cocoa liquor | 30.4 |
| Sugar | 54.3 |
| Cocoa powder | 4.9 |
| Lactose | 4.9 |
| Milk fat | 2.9 |
| Cocoa butter | 1.9 |
| Lecithin | 0.4 |
| PGPR | 0.3 |
| Vanillin | 0.02 |

All ingredients except PGPR and 0.23% of lecithin were weighed into a Hobart bowl and mixed well at 45° C. The mixture was then refined to a particle size of about 27 microns with the refiner setting at 40° C. The refined material was agitated in excess of 2 hours while being heated to a temperature of about 46° C. Remaining lecithin and the PGPR were added during the mixing and a dough was formed at end of mixing.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for creating a confectionery product comprising:
providing a mixture comprising a chocolate compatible fat and a sweetener; thereafter
refining the mixture to form a powder having a predetermined average particle size; thereafter
agitating the refined powder mixture at a temperature above the melting temperature of the chocolate compatible fat to form a dough; and thereafter
solidifying the dough to form a confectionery product having a total formulated fat content of less than 29% by weight.

2. The method of claim 1, wherein the amount of fat present in the mixture being refined is substantially the same as the amount of fat present in the formed confectionery product.

3. The method of claim 1, further comprising forming the dough into pieces intermediate the steps of agitating and solidifying.

4. The method of claim 3, wherein the step of forming includes at least one operation selected from the group consisting of rotary molding, sheeting, extrusion, depositing, drop rolling, stamping, frozen cone and panning.

5. The method of claim 1, wherein the provided mixture comprises chocolate liquor and the method further comprises conching the mixture.

6. The method of claim 1, wherein the provided mixture further comprises milk.

7. The method of claim 6, wherein the milk is provided as powdered milk.

8. The method of claim 1, wherein the step of refining is accomplished above the melting temperature of the chocolate compatible fat.

9. The method of claim 1, wherein the chocolate compatible fat is a tempering fat.

10. The method of claim 9, wherein the method further comprises tempering the dough in the presence of greater than about 0.3% by weight tempering seed.

11. The method of claim 1, wherein the chocolate compatible fat comprises a fat selected from the group consisting of cocoa butter, cocoa butter equivalents, cocoa butter replacements, cocoa butter substitutes, and mixtures thereof.

12. The method of claim 1, wherein the confectionery product is formed having a fat content in the range of about 18% and about 24% by weight.

13. The method of claim 1, wherein the confectionery product is formed having a fat content in the range of about 20% to about 22% by weight.

14. The method of claim 1, wherein the provided mixture further comprises an emulsifier present as about 0.3% to about 2% by weight.

15. A method for creating a confectionery product comprising:
providing a mixture comprising a chocolate compatible tempering fat, milk, cocoa solids, sugar and an emulsifier; thereafter
refining the mixture to form a chocolate powder having an average particle size in the range of about 15 to about 40 microns at a temperature greater than the melting temperature of the chocolate compatible tempering fat; thereafter
agitating the refined chocolate powder mixture at a temperature above the melting temperature of the chocolate compatible tempering fat to form a dough in the presence of an additional added emulsifier;
tempering the dough in the presence of greater than about 0.3% by weight tempering seed;
forming the dough into a predetermined shape; and thereafter
solidifying the dough to form a confectionery product having a total formulated fat content of 27% or less by weight.

16. The method of claim 15, wherein the chocolate powder is refined to an average particle size in the range of about 25 to about 30 microns.

17. The method of claim 15, wherein the confectionery product is formed having a total formulated fat less than about 24% by weight.

18. The method of claim 17, wherein the confectionery product is formed having a fat content in the range of about 20% to about 22% by weight.

19. The method of claim 15 wherein the chocolate compatible tempering fat comprises cocoa butter.

20. A confectionery product formed according to the method of claim 1.
